(19) United States
(12) Patent Application Publication
(10) Pub. No.: US 2012/0166252 A1
(43) Pub. Date: Jun. 28, 2012

(54) Methods and Apparatus to Generate and Present Information to Panelists

(76) Inventor: Kris Walker, Newington (AU)

(21) Appl. No.: 12/976,471

(22) Filed: Dec. 22, 2010

(51) Int. Cl. G06Q 30/00

(52) U.S. Cl. 705/7.32

(57) ABSTRACT

Methods and apparatus to generate and present information to panelists are disclosed. An example method includes receiving product data associated with a product purchased by a panelist; generating a first profile for the panelist based on a characteristic related to the product; generating comparative data between the first profile for the panelist and a composite profile related to a population; and conveying the comparative data to the panelist.

### FIELD OF THE DISCLOSURE

This disclosure relates generally to consumer research, and, more particularly, to methods and apparatus to generate and present information to panelists.

### BACKGROUND

In some consumer market research systems, groups of panelists agree to passively and/or actively submit information about their demographics and their behavior to a data collection entity that uses the information to develop reports about populations of interest. The submitted information may include data related to, for example, purchased products, media exposure, demographics (e.g., age, gender, race, income, home location, occupation, etc.) advertisement exposure, etc. The data collected from the panelists can be extrapolated to provide estimations of behaviors of a broader population, such as a demographic group that shares certain traits with the panelists. The data collection entity, or some other entity with access to the submitted information, typically generates reports using the submitted information and/or the extrapolated estimations and provides the reports and/or the data to, for example, providers of goods and services that advertise to targeted audiences.

### BRIEF DESCRIPTION OF THE DRAWINGS

FIG. 1 is a schematic illustration of a disclosed consumer market research system to collect data related to purchases made by one or more panelists.

FIG. 2 is a block diagram of an example apparatus that may be used to implement the example panelist feedback provider of the example consumer market research system of FIG. 1.

FIG. 3 is a screenshot of an example presentation generated by the example panelist feedback provider of FIGS. 1 and/or 2.

FIG. 4 is a flowchart representative of example machine readable instructions that may be executed to implement the example analysis module of FIG. 1, the example panelist feedback provider of FIGS. 1 and/or 2, and/or the example system of FIG. 1.

FIG. 5 is an example processor platform capable of executing the example machine readable instructions of FIG. 4 to implement the example analysis module of FIG. 1, the example panelist feedback provider of FIGS. 1 and/or 2, and/or the example system of FIG. 1.

### DETAILED DESCRIPTION

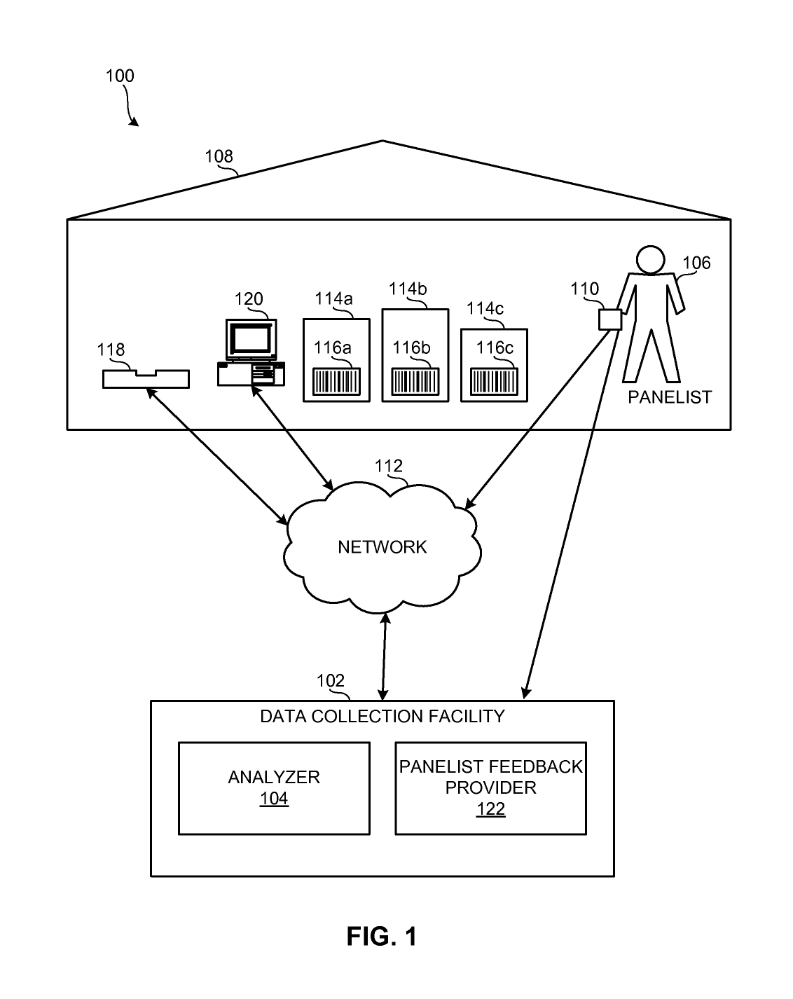

FIG. 1 is a schematic illustration of an example market research system 100 including a data collection facility 102. The example data collection facility 102 of FIG. 1 collects data related to actions and/or behaviors exhibited by, for example, a plurality of panelists (e.g., panelist 106) that have agreed to actively and/or passively submit data to the data collection facility 102. Although for simplicity of illustration FIG. 1 shows only a single panelist 106, multiple panelists participate in the example market research system 100 of FIG. 1. In the illustrated example, the panelist 106 is a member of a panel that has agreed to scan the barcodes of merchandise he or she purchases using a barcode scanning device provided by a data collection entity associated with the data collection facility 102. However, other types of panels (e.g., television panels, radio panels, Internet panels, etc.) to measure additional or other activities may likewise be employed.

The example data collection facility 102 of FIG. 1 includes an analyzer 104 to analyze the collected data and/or to generate reports using the collected data. For example, the analyzer 104 may analyze collected data and/or generate reports regarding exposure to media (e.g., television programming, radio programming, music, movies, printed publications, advertisements, web pages, Internet content, etc.), product purchases and/or, shopping habits. The example analyzer 104 of FIG. 1 supplies and/or sells extrapolations, estimations, and/or raw data to, for example, providers of goods and/or services, financial analysis firms, advertising agencies, media planners, creative agencies, etc.

In the illustrated example of FIG. 1, a panelist 106 has agreed to submit data identifying products he or she has purchased to the data collection facility 102. The example panelist 106 of FIG. 1 is a member of a household 108 that may include additional household members. The panelist 106 and/or the household 108 may be statistically selected (e.g., by an entity operating the data collection facility 102) according to, for example, one or more demographic factors, geographic location, answers provided in response to a survey, previous purchase behavior, etc. The product data submitted to the data collection facility 102 may include information related to products obtained (e.g., purchased, traded for, received for free, etc.) and by a single household member (e.g., the panelist 106), the household as a whole, and/or any subset of household members (e.g., children, parents, males, females, an eldest child, etc.) and point of sale data (e.g., retailer name and address, wholesaler name and address, etc.). Furthermore, the product data to be submitted to the data collection facility by the panelist 106 and/or the household 108 may include, for example, any type of products, a designated type of product (e.g., groceries, clothing, media (e.g., music or movies), electronics, housekeeping products, home improvement products, etc.), a designated brand, and/or a plurality of types of products. As described above, the analyzer 104 of the example data collection facility 102 illustrated in FIG. 1 uses the submitted product data from the panelist 106 in combination with other data collected in connection with other panelists and/or households, to generate reports regarding, for example, purchasing habits of populations of interest.

The panelist 106 may convey the product data to the data collection facility 102 in any suitable manner. In the illustrated example of FIG. 1, the panelist 106 is a member of the Homescan® panel operated by The Nielsen Company (US), LLC. Nielsen provides such panelists with a scanner 110 (e.g., a barcode scanner) which is adapted to collect data (e.g., via the barcode reader) and to communicate that collected data to the data collection facility 102 either directly and/or via a network 112. Although the example market research system 100 of FIG. 1 is illustratively shown with a single network, the example network 112 may be implemented by one or more networks, such as a local-area network, a wide-area network, a metropolitan-area network, the Internet, the Plain Old Telephone System (POTS), a digital subscriber line (DSL) network, a cable network, a power line network, a wireless communication network, a wireless mobile phone network, a Wi-Fi network, and/or a satellite network.

More specifically, after purchasing a product (and typically, but not necessarily, after the panelist 106 has returned home), the panelist 106 uses the example scanner 110 to scan identifying information on products 114 purchased or otherwise obtained by the panelist 106 and/or another member of the household 108. In the illustrated example of FIG. 1, the identifying information on each product 114 is a barcode 116. However, any type of identifying information may be utilized. For example, the scanner 110 may be provided with a key pad or other user device to enable the user to manually enter the product information (e.g., product name, point of sale, etc.). Each barcode 116 is unique to the respective product 114 such that the products 114 can be identified using data obtained from the barcodes 116. For example, each barcode 116 may correspond to a SKU (stock-keeping unit) associated with a specific product. The example scanner 110 of FIG. 1 electronically stores data corresponding to the scanned barcodes 116 in a memory.

The example scanner 110 transmits (e.g., periodically, after scanning new information, and/or in response to an event or prompt) the stored identifying information to the data collection facility 102 in any suitable manner. In some examples, the scanner 110 includes a wireless communication module (e.g., a cellular module) capable of wirelessly transmitting the stored data corresponding to the scanned barcodes 116 to the data collection facility 102. In some examples, the scanner 110 is coupled to a docking station 118, which is communicatively coupled to the data collection facility 102 (e.g., via the network 112, via a wireless communication module installed on the docking station 118 or via the personal computer 120), and which may charge the scanner 110. In some examples, the scanner 110 is coupled to a personal computer 120, which is communicatively coupled to the data collection facility 102 (e.g., via the network or via a wireless communication module installed on the personal computer 120). While the example of FIG. 1 includes a personal computer 120, any other type of device capable of interacting with the scanner 110 to transmit the stored codes to the data collection facility 102 may be employed. The scanner 110 may be able to use one, some, or all of these communication technologies.

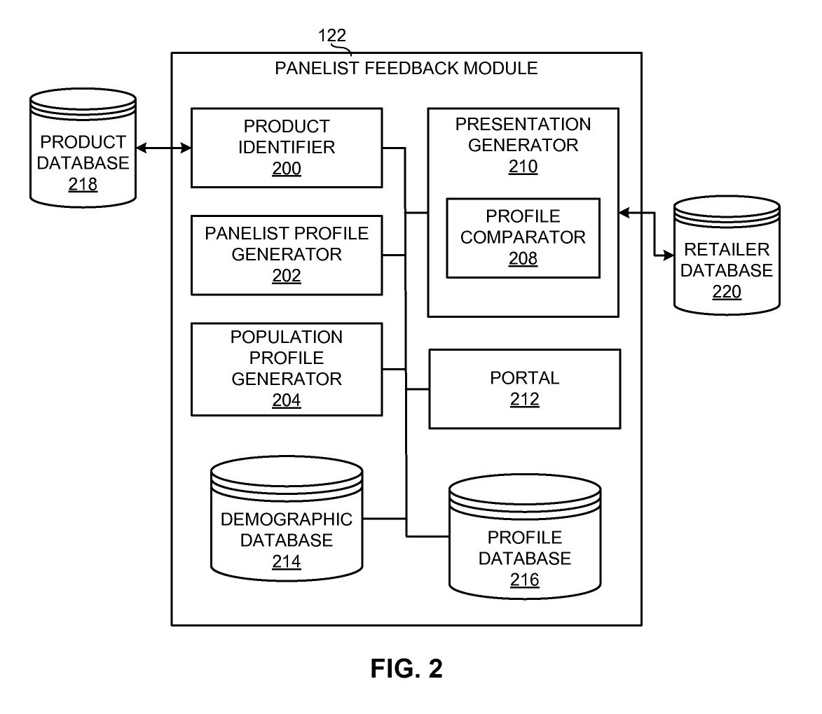

As described above, the example analyzer 104 of the example data collection facility 102 of FIG. 1 uses collected information received from the scanner 110 and/or from other panelists, in one or more analyses to study and/or draw conclusions concerning consumer behavior, purchasing habits, etc. The example data collection facility 102 of FIG. 1 also includes a panelist feedback provider 122. The example panelist feedback provider 122 provides panelists (e.g., the panelist 106) with information related to, for example, their purchasing and/or consumption behaviors, either in isolation or relation relating to other panelists and/or populations of interest. In the example of FIG. 1, the example panelist feedback provider 122 provides the panelist 106 with information related to the products 114 the panelist 106 has purchased. As described in detail below, this information may include characteristics or traits associated with the products 114, such as nutritional facts, pricing, location of production, sales or discounts associated with the products 114, etc. The information may be provided to the panelist(s) in any suitable format. In the illustrated example, the panelist feedback provider 122 generates a profile for the panelist 106 based on the characteristics or traits of the products purchased by the corresponding panelist. The profile generated by the example panelist feedback provider 122 (and/or any other information collected by the example panelist feedback provider 122 of interest to panelists thereof) is conveyed (e.g., via a portal accessible by the panelist 106 via the personal computer 120 of FIG. 1) to the panelist in question (e.g., the panelist 106 of FIG. 1). Additionally or alternatively, the example panelist feedback provider 122 may provide the panelist 106 with comparative data comparing the generated profile of the panelist 106 with one or more composite profiles corresponding to population(s) of interest (e.g., populations sharing one or more demographic characteristics with the panelist 106). In some examples, the panelist 106 is able to select the population(s) of interest for which the one or more composite profiles are provided. The composite profile(s) may correspond to, for example, other panelists or any other suitable group of people and/or households. Additional aspects, operations, and details of the example panelist feedback provider 122 are described below in connection with FIGS. 2-4.

In some examples, the feedback provided to the panelist 106 by the example panelist feedback provider 122 may influence the behavior of the panelist 106. However, for some purposes, it may be desirable to analyze behavior that is uninfluenced or largely uninfluenced by the panelist feedback provider 122. In such instances, the data received from the panelist 106 may be omitted from the analyses of the example analyzer 104 and only data collected from panelists that do not receive feedback may be used for such analyses.

However, in some examples, the possibility of influencing behavior through the feedback of the feedback provider 122 is acceptable. In such cases, the data received from the panelist 106 may be utilized by the analyzer 104. In some examples, the panel may be mixed to include panelists that receive feedback from the feedback provider 122 and panelists who do not. For example, feedback may only be provided to panelists who have participated in the panel for a long period of time (e.g., two years). In some such examples, providing feedback to panelists after they have participated for a certain length of time may be useful to extend the length of time the person is willing to participate. For instance, if the typical panelist quits a panel after one year in the absence of feedback information, offering the incentive to persons who participate in the panel at least one year may extend the time they will remain on the panel. Because such persons may have quit the panel in the absence of the feedback incentive, it may be better to have a larger panel with more longevity or some quantity of panelists influenced by the feedback than a smaller panel with no feedback influence. In the context of mixed panels, the analyzer 104 may consider the fact that the panelist 106 is one that receives feedback from the panelist feedback provider 122 when conducting analyses of collected data and, for example, use the data associated with that panelist accordingly relative to data collected from an uninfluenced panelist. In some instances, the analyzer 104 may study how the provided feedback by the panelist feedback provider 122 influences consumer behavior by comparing the behavior of panelists receiving feedback from the panelist feedback provider 122 and the behavior of the panelists not receiving such feedback.

FIG. 2 illustrates an example apparatus that may be used to implement the example panelist feedback provider 122 of the example consumer system 100 of FIG. 1. The example panelist feedback provider 122 of FIG. 2 includes a product identifier 200, a panelist profile generator 202, a population profile generator 204, a profile comparator 208, a presentation generator 210, a portal 212, a demographic database 214, and a profile database 216. While an example manner of implementing the example panelist feedback provider 122 of FIG. 1 is illustrated in FIG. 2, one or more of the elements, processes and/or devices illustrated in FIG. 2 may be combined, divided, re-arranged, omitted, eliminated and/or implemented in any other way. Further, the example product identifier 200, the example panelist profile generator 202, the example population profile generator 204, the example profile comparator 208, the example presentation generator 210, the example portal 212, and/or, more generally, the example panelist feedback provider 122 of FIG. 2 may be implemented by hardware, software, firmware and/or any combination of hardware, software and/or firmware. Thus, for example, any of the example product identifier 200, the example panelist profile generator 202, the example population profile generator 204, the example profile comparator 208, the example presentation generator 210, the example portal 212, and/or, more generally, the example panelist feedback provider 122 of FIG. 2 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus claims are read to cover a purely software and/or firmware implementation, at least one of the example product identifier 200, the example panelist profile generator 202, the example population profile generator 204, the example profile comparator 208, the example presentation generator 210, and the example portal 212, are hereby expressly defined to include a computer readable medium such as a memory, DVD, CD, etc. storing the software and/or firmware. Further still, the example panelist feedback provider 122 of FIG. 2 may include one or more elements, processes and/or devices in addition to, or instead of, those illustrated in FIG. 2, and/or may include more than one of any or all of the illustrated elements, processes and devices.

The example panelist feedback provider 122 of FIG. 2 receives data collected from the example panelist 106 by the analyzer 104 of FIG. 1. In the illustrated example, the example analyzer 104 receives data identifying products purchased by the panelist 106, the stores from which the products were purchased, and/or the prices paid for the products. The products may be identified by, for example, scanning their barcodes 116 (e.g., Universal product codes (UPC)) with the example scanner 110, by manually entered data (e.g., a brand name and product type) input by manipulation of one or more input devices (e.g., a keyboard, a mouse, etc.), and/or by other input methods and/or devices, such as via a picture taken with, for example, a smartphone device with visual search technology implemented thereon. As described above, the panelist 106 is provided with the scanner 110 to facilitate entry of the barcodes 116 associated with the products 114 purchased by the panelist 106 and/or another member of the panelist household 108. The scanner 110 also includes an alphanumeric keypad and/or other input devices to enable the user to manually input data such as a point of purchase identifier identifying a specific store, pricing information, UPC code, date and/or time of purchase, etc. Although the example scanner 110 of FIG. 1 is a specialized scanning device, the scanner may alternatively be implemented in a non-dedicated mobile device, such as a smart phone having a camera or other imaging device, capable of scanning products and conveying collected data to the data collection facility 102 (e.g., using a cellular module).

Irrespective of the precise mechanism employed to collect the data, the example panelist feedback provider 122 has access to identifying information (e.g., UPC codes) corresponding to the products 114 purchased or otherwise obtained by member(s) of the panelist household 108. The example product identifier 200 of FIG. 2 uses the identifying information (e.g., UPC codes) to compile a list of the products 114 purchased by the panelist 106. To this end, the example product identifier 200 of FIG. 2 accesses a product database 218 (e.g., a Nielsen® item master database mapping product identifiers, such as UPC codes, to product types, brands, and/or manufacturer) to compile a user friendly list of the products 114 purchased by the panelist 106 within a time period of interest. In the example of FIG. 2, the product database 218 is external to the example panelist feedback provider 122. For example, the product database 218 may be maintained elsewhere in the data collection facility 102 and may be utilized by and/or part of other mechanisms, such as the analyzer 104. However, in some examples, the product database 218 may be implemented as part of the example panelist feedback provider 122.

After receiving product identifying data (e.g., a UPC code), the example product identifier 200 queries the product database 218 using the product identifying data received from the scanner 110. For product identifying data or code that has a corresponding product in the product database 218, the product database 218 returns an identification of the corresponding product. The returned identification includes, for example, a brand name, a sub-brand name, a generic product description, a size (e.g., volume, quantity, etc.), and/or any other descriptive product information of interest. Thus, the example product identifier 200 obtains user friendly identifications of the products 114 that can be comprehended by the panelist 106.

The example product database 218 also returns one or more characteristics associated with the products 114 to the product identifier 200. Example characteristics include nutritional facts (e.g., when the product is food), such as calories per serving, percentages for each daily recommended nutrients, fat content, etc. Other example characteristics include price, categorization(s), classification(s), location of production, on-sale information, date of release, media type, genre, and/or any other trait, aspect, feature, etc. available in the database 218.

In some examples, the product database 218 includes one or more open-source portions accessible to external individuals and/or organizations. In some examples, the open-source portions are accessible, for example, in exchange for a fee and/or as part of an agreement between the data collection facility 102 and the authorized individuals and/or organizations. Generally, the open-source portions of the product database 218 enable those having access to develop, for example, applications or programs that utilize the content of the product database 218. For example, the applications or programs can utilize the content of the product database 218 by appending or linking information (e.g., data from datasets of the external individuals or organizations) to and from the content of the product database 218 (e.g., via functions calls formatted according to protocols or configurations of the product database 218). The open-source portions of the product database 218 can be utilized in additional or alternative ways for development of additional or alternative services, devices, and/or features.

When the product database 218 does not include an entry corresponding to received product identifying data or a code (e.g., a UPC code), the product database 218 informs the product identifier 200 of the lack of an entry for the scanned product. In such instances, a message is conveyed to the panelist 106 (e.g., to the scanner 110 and/or the personal computer 120) informing the panelist 106 that the scanned product is not known. In the illustrated example, the message includes a request for the panelist 106 to convey a description including a product type, brand, name and manufacturer of the unregistered product to the data collection facility 102. The data collection facility 102 may add the product to the product database 218 along with the description provided by the panelist 106. In some examples, the data collection facility 102 may maintain a list of unregistered products that have been described by a panelist. Products from this list can be added to the product database 218 when a threshold number of panelists have similarly described the product associated with the unregistered product identifying data or code (e.g., a UPC code). The description of the unregistered product can be verified in additional or alternative manners before the product is added to the product database 218. Although the process of requesting description of unknown products has been described as associated with the panelist feedback provider 122, in some examples such requests are performed by another part of the system substantially contemporaneously with the upload of data from the panelist 106 or by the scanner 110 to make it more likely that the panelist 106 describes the correct product with the unknown UPC or other type of product identifying data.

In some examples, when the product database 218 does not include an entry corresponding to received product identifying data or a code (e.g., a UPC code), a message is conveyed to an identification group or system capable of identifying the unregistered product using the received product identifying data. In such instances, the group or system may be associated with the data collection facility 102 of FIG. 1. The message sent to the identification group or system can be sent in addition to or in lieu of the message sent to the panelist 106 requesting descriptive information.

The example panelist profile generator 202 of FIG. 2 uses the information obtained by the example product identifier 200 and/or information stored in one or more additional databases, such as the demographic database 214, to generate a profile for the panelist 106. In the illustrated example, the demographic database 214 stores demographic data related to the panelist 106, the household 108, and/or other panelists and households associated with the panelist feedback provider 122 and/or non-panelists. In the illustrated example, the profile summarizes different aspects of the purchasing behavior, consumption habits, and/or other trends of the panelist 106 and/or the household 108. For example, the profile associated with the panelist 106 may include a breakdown of monthly spending on different types of products, such as groceries, pharmaceuticals, entertainment (e.g., periodicals, books, movies, etc.) clothing, household goods (e.g., cleaning products, utensils, appliances, electronic, etc.).

In some examples, the breakdown includes data related to budget(s) set by, for example, the panelist 106 for a certain period(s) of time (e.g., a week, a month, a quarter, a year, etc.). For example, the budgetary breakdown of the panelist profile indicates whether the household 108 is complying with the budget(s) or exceeding the budget(s) and/or monetary differences between expenditures and the budget(s).

In some examples, the profile associated with the panelist 106 includes savings information using on-sale information stored in the product database 218 (this information may have been provided by the panelist 106 or by matching the UPC code and point-of-sale information from the panelist 106 to a database of pricing obtained from corresponding stores.

In some examples, the panelist profile generator 202 uses nutritional facts associated with the products 114 obtained by the example product identifier 200 to generate an overall eating habits summary for the panelist 106 and/or the household 108. Such an eating habits summary may include, for instance, nutritional summaries identifying caloric intake, consumed saturated fat, carbohydrate intake, protein intake, sugar intake, etc. The health or wellness information in the profile may be generated by summing the nutritional values of each food-related product purchased or otherwise obtained during a period of time of interest, such as a week or two weeks. Additionally or alternatively, the panelist profile generator 202 may juxtapose the nutritional values of the products 114 against recommended values (e.g., daily intake values for certain nutrients recommended by an organization such as the Food and Drug Administration). For example, the profile may include percentages of recommended amounts of certain nutritional categories represented by the purchased food products. Other reports may be provided such as sustainability and/or environmental aspects of the panelist behavior. In some examples, the panelist profile generator 202 generates a percentage of groceries obtained by the panelist 106 that are environmentally sustainable products and/or a percentage of the groceries that are from a local producer.

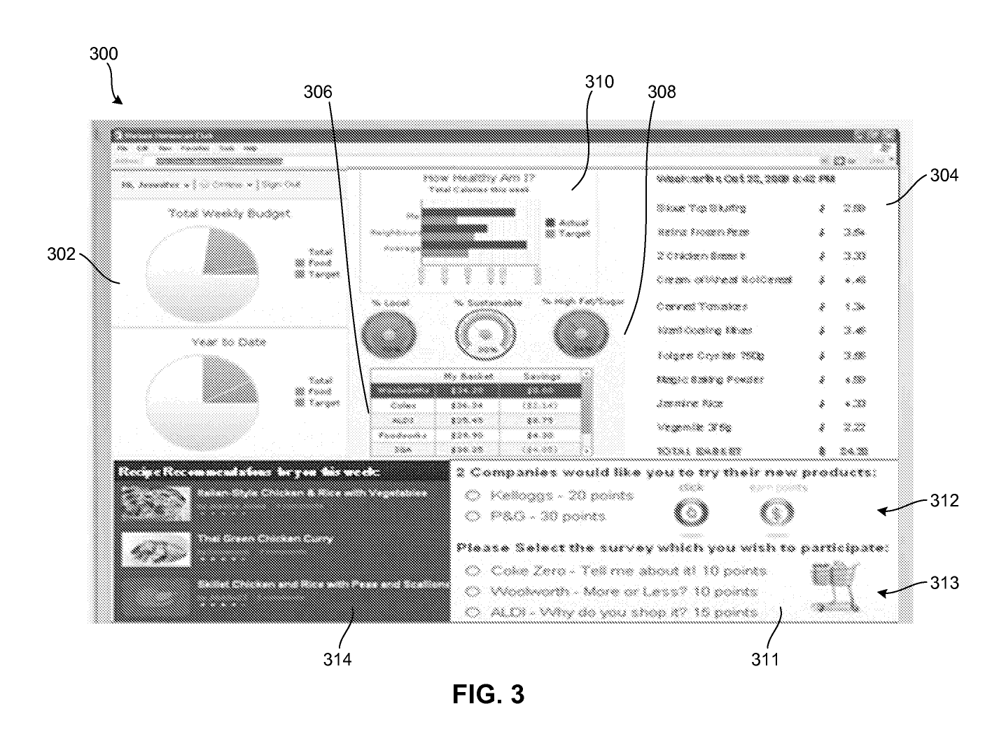

The example panelist profile generator 202 conveys the panelist profiles to the profile database 216 and updates the profiles when, for example, new identifying information is received, according to a schedule, and/or at any other suitable time. An example profile generated by the example panelist profile generator 202 is described in greater detail below in connection with FIG. 3.

The example population profile generator 204 of FIG. 2 generates one or more composite profiles for one or more groups of people using information received from panelists (e.g., including the panelist 106 of FIG. 1) and/or information obtained from one or more additional databases 218, such as the demographic database 214. The composite profile(s) are indicative of, for example, purchasing behaviors and/or consumption activities of the corresponding groups of panelists. The composite profile(s) may include, for example, averages, medians, maximums, minimums, and/or any other type of statistic(s) for the collected data. In the illustrated example of FIG. 2, the population profile generator 204 generates composite profiles having similar parameters or categories as the profiles generated by the example panelist profile generator 202. Also, in the illustrated example, the groups of people for which the population profile generator 204 generates composite profile(s) are defined by demographics associated with the panelist and/or household of interest. For instance, if the panelist household 108 is an upper-middle class Hispanic family with a mother, a father, a son and a daughter, ages twelve and nine, the data used by the population profile generator 204 may be associated with panelists having similar demographic characteristics. Any type(s) of information or demarcations can be used to define the groups for which the example population profile generator 204 generates composite profiles. These selections may be defined by the feedback provider 122 and/or may be selectable and/or adjustable based on inputs received from the panelist 106.

The example presentation generator 210 of FIG. 1 generates a presentation to be conveyed to the panelist 106. Generally, in the illustrated example, the presentation generator 210 generates a presentation including, for example, purchase information related to the products 114, one or more aspects of the profile of the panelist 106, one or more comparisons between the profile for the panelist 106 and one or more composite profiles associated with panelists and/or households having similar demographic(s) as the panelist 106, and/or one or more offers from one or more retailers. This and any additional or alternative information to be included in the presentation may be communicated via charts, graphs, tables, lists, multiple pages, and/or any suitable graphic or display. Also, the presentation generator 210 may generate different versions of the presentation such that the information thereof can be communicated to and/or viewed by a plurality of different devices. That is, the presentation generator 210 may generate the presentation in a plurality of different formats, protocols, programming languages, etc. that may be used by different devices. Thus, while the presentation generator 212 of the illustrated example of FIG. 2 generates a presentation formatted to be viewed on a web browser being executed on the personal computer 120 of the example household 108 of FIG. 1, the example presentation generator 212 may generate presentation(s) in additional or alternative formats to be viewed on additional or alternative devices. The presentation may be generated in a language of use to the panelist 106 (e.g., based on demographic information related to ethnicity and/or information provided by the panelist 106 regarding a primary language).

When the presentation generator 210 is to generate a presentation including one or more comparisons between the profile for the panelist 106 and one or more composite profiles associated with panelists and/or households having similar demographic(s) as the panelist 106, the presentation generator 210 employs the profile comparator 208. In the illustrated example, the profile comparator 208 of FIG. 2 accesses the profile database 216 to retrieve a profile associated with the panelist 106 and a composite profile associated with a population having demographic(s) similar in one or more respects of interest to the demographic(s) of the panelist 106 and/or the household 108. As described above, the composite profiles generated by the population profile generator 204 include statistic(s) (e.g., averages, medians, maximums, minimums, etc.) indicative of, for example, purchasing behaviors and/or consumption activities of the corresponding group(s) of panelists. The example profile comparator 208 of FIG. 2 compares the profile of the panelist 106 generated by the panelist profile generator 202 to the composite profile(s) generated by the example population profile generator 204. From the comparison(s), the example profile comparator 208 generates comparative data reflective of a relationship between the panelist profile and the composite population profile(s) and, thus, indicates how the purchasing behavior and/or consumption habits of the household 108 compares to the purchasing behavior and/or consumption habits of a group of people having similar demographic traits as the household 108. The example presentation generator 210 of FIG. 2 processes the comparative data generated by the profile comparator 208 to create one or more presentations to be conveyed to the panelist 106. The example presentation generator 210 of FIG. 2 also enables the panelist 106 to customize one or more aspects of the presentations according to, for example, preferences of the panelist 106 and/or selectable options presented in conjunction with the presentations. An example of such a presentation is described below in connection with FIG. 3.

The example presentation generator 210 of FIG. 2 also processes the profile associated with the panelist 106 to create one or more presentations including information obtained from data associated with other panelists or populations. In other words, the example presentation generator 210 of FIG. 2 provides the panelist 106 with user friendly representations of one or more aspects of the profile generated by the example panelist profile generator 202. An example of such a presentation is described below in connection with FIG. 3.

The example presentation generator 210 of FIG. 2 also accesses one or more external databases to obtain information for additional or alternative presentations. In the illustrated example of FIG. 2, the presentation generator 210 accesses a retailer database 220, which includes a plurality of listings corresponding to a plurality of retailers and/or other providers of goods and/or services. In some examples, the retailer database 220 includes advertisements in the form of objects to be included in a webpage. In some examples, the retailer database 220 includes offers from retailers, such as opportunities to join a club, to take a survey, to purchase a sample of an item, and/or other type(s) of offers. In some examples, the data of the retailer database 220 is labeled with a target demographic such that the information provided thereby is customized for certain types of people, groups, and/or households. While the example of FIG. 2 is shown with a retailer database 220, the example presentation generator 210 may access additional or alternative types of databases (e.g., a recipe database to including one or more recipes that can be recommended to the panelist 106 via a presentation generated by the presentation generator 210) and/or other sources of similar information.

The presentation generated by the example presentation generator 210 is made accessible to the panelist 106 via the example portal 212. In the illustrated example, the portal 212 can be accessed by the panelist 106 via a web browser implemented on the personal computer 120 of FIG. 1. The panelist 106 may be required to login to the portal 212 using a username and password to access the presentation. The example portal 212 of FIG. 2 is also accessible in additional or alternative manners by additional or alternative devices such as, for example, a dedicated application on a mobile device (e.g., a smart phone or personal digital assistant). Further, the presentation generated by the example presentation generator 210 can be conveyed to the panelist 106 in alternative manners, such as via postal mail, electronic mail, and/or facsimile.

FIG. 3 is a screenshot of an example presentation 300 generated by the example panelist feedback provider 122 of FIGS. 1 and/or 2. The screenshot shown in FIG. 3 corresponds to a display produced by a web browser implemented on the personal computer 120 of FIG. 1. For example, the panelist 106 can enter a web address associated with the portal 212 of FIG. 2 into an address bar of a web browser to gain access to the presentation 300. However, as described above in connection with FIG. 2, the example presentation 300 may be accessible by the panelist 106 in additional or alternative manners via additional or alternative devices.

As described above, the example presentation generator 210 of FIG. 2 uses information of a profile of the panelist 106 and/or household 108 to generate the presentation 300. In the illustrated example, the presentation 300 includes a budget section 302 to display budgetary data associated with the household 108. The displayed budgetary data of the panelist profile includes information related to budget(s) established by the panelist 106 (e.g., by interacting with the portal 212 via a user interface implemented by a web browser on the personal computer 120) for certain period(s) of time (e.g., a week, a month, a year, etc.) and whether the panelist 106 complied with or exceeded the budget(s). While the budget section 302 of the example presentation 300 includes pie charts for the budget information, any additional or alternative suitable type of graphic or numeric display can be utilized.

The example presentation 300 of FIG. 3 includes a purchasing section 304 to display a list of products purchased on a particular day from a particular entity (e.g., a retail establishment). In the illustrated example, the purchasing section 304 lists each purchased product and a corresponding price. In the context of FIG. 1, the lists in the purchasing section 304 include one or more of the products 114 scanned by the example scanner 110. The panelist 106 can manipulate the presentation 300 such that additional or alternative days and/or entities are displayed in the purchasing section 304.

The example presentation 300 of FIG. 3 also includes a savings section 306 to display one or more indications of an amount of money the panelist 106 would have saved or lost had the panelist 106 purchased the products listed in the purchasing section 304 from an alternative entity (e.g., retailers), such as a retailer offering one or more of the purchased products at a discount or at a regularly lower price. In the illustrated example, four entities are listed in a table that includes a savings column showing an amount of money the panelist 106 would have saved or lost had the corresponding purchase been made at each of the alternative entities. To calculate these potential savings of the purchasing section 304, the example presentation generator 210 (e.g., via the product identifier 200) obtains pricing information from the product database 218. In some examples, the panelist 106 may be able to select which alternative entities are listed in the savings section 306 based on, for example, which of the entities are located within a certain distance from a geographic location of the household 108. In some examples, the presentation 300 includes an input to limit the entity listings to those within a designated distance from the geographic location of the household 108.

The example presentation 300 of FIG. 3 also includes a food-trait section 308 to display one or more dials that show percentage(s) associated with one or more food categories. To generate the food-trait section 308, the example presentation generator 210 of FIG. 2 obtains data from the product database 218, which includes characteristics (e.g., nutritional values) associated with food-related products. In the illustrated example, the food-trait section 308 includes a first dial indicative of a percentage of food purchased by the household 108 which is produced locally (e.g., within a certain distance of a geographic location of the household 108) and/or not by a mass producer. Further, the example of FIG. 3 includes a second dial indicative of a percentage of food purchased by the household 108 which is sustainable (e.g., produced with reduced amounts of resources to aid in the sustainability of the renewable resources used to produced the food). Further, the example of FIG. 3 includes a third dial indicative of a percentage of food purchased by the household 108 which is high in fat or sugar according to a threshold set, for example, by the FDA and/or by the user. The nutritional category shown in the third dial can be altered by the panelist 106 and/or additional dials can be added to the example food-trait section 308 to indicate additional nutritional categories. Additional or alternative dials and/or other types of graphics can be included in the example food-trait section 308 of FIG. 3.

The example presentation 300 of FIG. 3 also includes a wellness section 310 to display one or more indications of a wellness measurement associated with the household 108. The example presentation generator 210 of FIG. 2 uses data generated by the panelist profile generator 202, the composite profile generator 204, and/or the profile comparator 208 of FIG. 2 to generate the wellness section 310. In the illustrated example, the wellness section 310 of FIG. 3 includes a bar graph indicative of total caloric intake over the course of a week for the panelist 106. The bar graph includes an actual caloric intake associated with the panelist 106 displayed adjacent to a target caloric intake based on, for example, a recommended value or a value set by the panelist 106. The example wellness section 310 of FIG. 3 also includes actual and target caloric intakes associated with one or more populations using the data generated from the population profile generator 204. In the illustrated example of FIG. 3, a first group of people represented in the wellness section 310 includes households located within a certain distance of the household 108 (i.e., neighbors of the panelist 106). In the illustrated example, households are identified as neighbors of the example household 108 of FIG. 1 using the demographic information which includes a residency location) stored in the demographics database 214. A second group of people represented in the example wellness section 310 of FIG. 3 includes an overall population (e.g., nationwide, statewide, or citywide) having similar demographics as the household 108. In the illustrated example of FIG. 3, the second group is labeled as ‘average’ in the wellness section 310.

In some examples, the comparative data generated by the profile comparator 208 of FIG. 2 is displayed in the wellness section 310. For example, a ratio of the weekly caloric intake associated with the household 108 can be divided by, for example, the weekly caloric intake of the neighbors of the panelist 106 to generate a percentage. This percentage can be included in a graphic in the example wellness section 310 indicating that the panelist 106 consumed, for example, twenty percent fewer calories than his or her neighbors. Relationships between the household 108 and additional or alternative groups of panelists and/or non-panelists can be represented in the example wellness section 310.

The example presentation 300 of FIG. 3 also includes an offer section 311 to display one or more offers. In the illustrated example, a first offer 312 provides the panelist 106 with an opportunity to sample new products offered by two companies. In some examples, accepting the first offer 312 results in points (e.g., redeemable coupons) being awarded to the panelist 106 (e.g., via a printable coupon and/or via a transfer to an account registered in associated with the panelist 106). In some examples, accepting the first offer 312 may include placing an order for the new products associated with the first offer 312. In the illustrated example, a second offer 313 provides the panelist 106 with an opportunity to take one or more surveys offered by three companies. Similar to the first offer 312, accepting the second offer 313 results in point being awarded to the panelist 106. Accepting the second offer 313 may include being routed to a web site implementing the one or more surveys. The first and second offers 312 and 313 in the example presentation 300 of FIG. 3 are obtained from the example retailer database 220 of FIG. 2. As described above, the retailer database 220 of FIG. 2 includes data (e.g., offers to be included in the presentation 300) that is targeted to specific demographics and/or to potential purchasers of certain products. Thus, in the illustrated example, the presentation generator 210 can query the retailer database 220 using demographic information and/or purchaser information stored in the demographic database 214 and/or the product database 218 associated with the panelist 106. As a result, the offers provided in the example offer section 312 can be customized to the panelist 106 and/or the household 108.

The example presentation 300 of FIG. 3 also includes a recommendation section 314 to display one or more recommendations for the household 108. In the illustrated example, the recommendations include recipes obtained from an external database, such as the retailer database 220 of FIG. 2. In some examples, the panelist feedback provider 122 may employ a recipe recommendation service to recommend recipes based on the products 114 recently purchased by the panelist 106. Moreover, similar to the offers in the example offer section 312, the recommendations of the example recommendation section 314 of FIG. 3 may be customized for the panelist 106 and/or the household 108 based on, for example, demographics associated with the panelist 106 and/or the household 108.

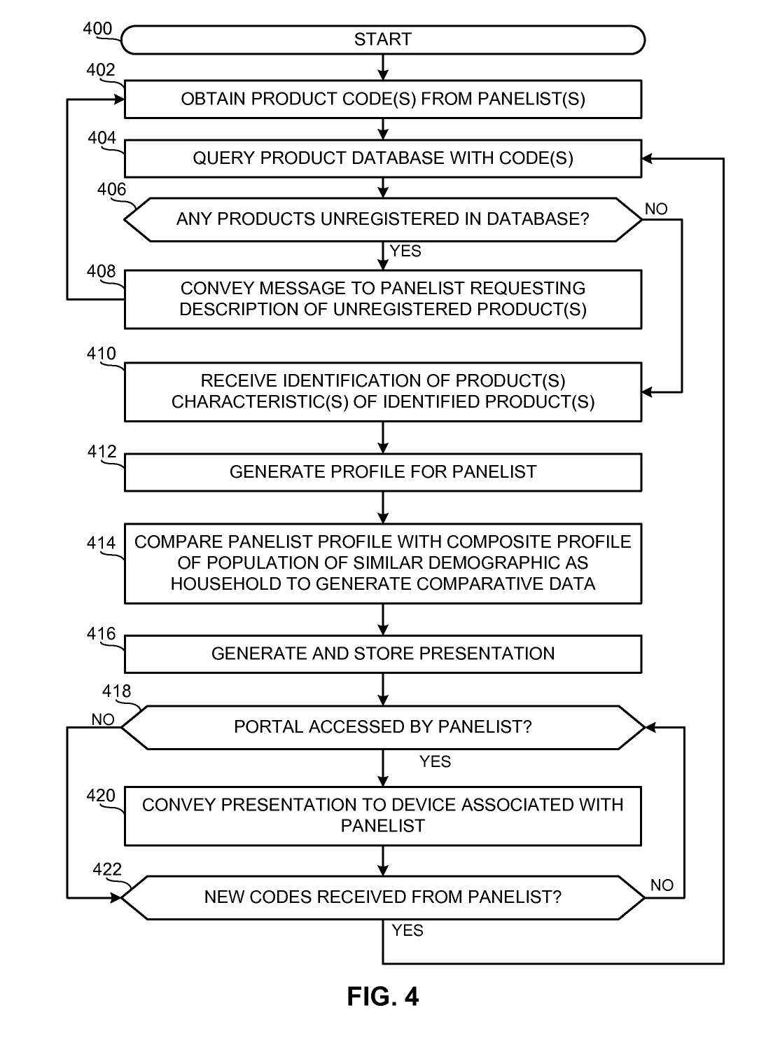

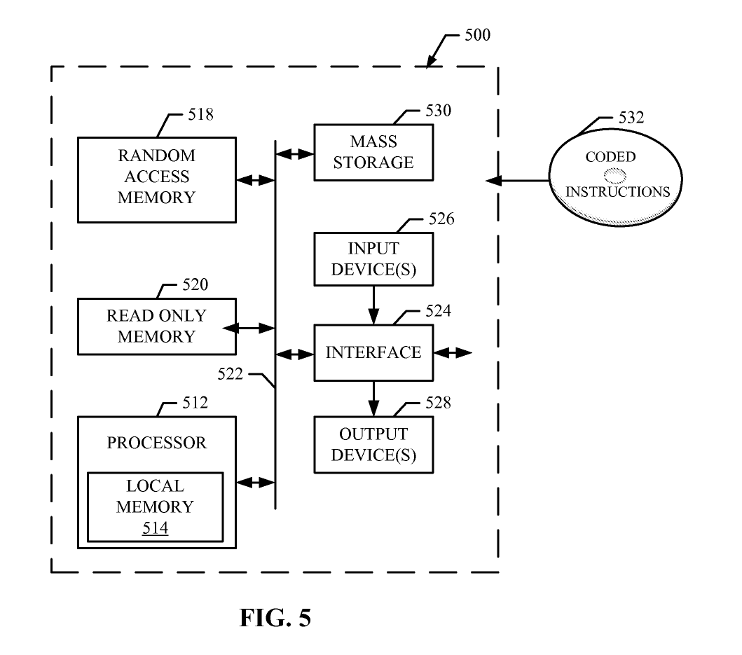

FIG. 4 is a flowchart representative of example machine readable instructions that may be executed to implement the example analyzer 104 of FIG. 1, the example panelist feedback provider 122 of FIGS. 1 and/or 2, and/or, more generally, the example data collection facility 102 of FIG. 1. In the example of FIG. 4, the machine readable instructions comprise a program for execution by a processor such as the processor 512 shown in the example computer 500 discussed below in connection with FIG. 5. The program may be embodied in software stored on a computer readable medium such as a CD-ROM, a floppy disk, a hard drive, a digital versatile disk (DVD), or a memory associated with the processor 512, but the entire program and/or parts thereof could alternatively be executed by a device other than the processor 512 and/or embodied in firmware or dedicated hardware. Further, although the example program is described with reference to the flowchart illustrated in FIG. 4, many other methods of implementing the example analyzer 104 of FIG. 1, the example panelist feedback provider 122 of FIGS. 1 and/or 2, and/or, more generally, the example data collection facility 102 of FIG. 1 may alternatively be used. For example, the order of execution of the blocks may be changed, and/or some of the blocks described may be changed, eliminated, or combined.

As mentioned above, the example processes of FIG. 4 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIG. 4 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

The program of FIG. 4 begins at block 400 when the panelist feedback provider 122 is activated. The panelist feedback provider 122 obtains code(s) and/or other product identification data (e.g., UPCs) that were conveyed to the analyzer 104 by the panelist 106 and/or other panelists participating in the service implemented by the example panelist feedback provider 122 (block 402). In the illustrated example, the code(s) obtained by the panelist feedback provider 122 correspond to the barcodes 116 of FIG. 1 read by the example scanner 110. As described above in connection with FIG. 1, the panelist 106 uses the scanner 110 to read the barcodes 116 associated with the products 114 purchased by the panelist 106 and/or another member of the household 108. The example product identifier 200 of FIG. 2 queries the product database 218 using the codes or product identifiers (block 404). In the illustrated example, when any of the codes or identifiers are associated with an unregistered product (e.g., a product for which a code is not stored in the product database 218) (block 406), a message is conveyed to the panelist 106 requesting a description of the unregistered code (block 408). When the panelist 106 provides such a description, the same is added to the product database 218. In some examples, the description provided by the panelist 106 is subject to a verification process before being added to the product database 218. In some examples, when any of the codes or identifiers are associated with an unregistered product (e.g., a product for which a code is not stored in the product database 218, the code or identifier is conveyed to an identification entity in lieu of sending a message to the panelist 106 requesting descriptive information. The identification entity may be a group associated with the data collection facility 102 of FIG. 1 tasked with of identifying the products) corresponding to the unregistered/unknown code(s).

When the product database 218 does include an entry for the code(s) used to query to the product database 218, the product database 218 returns information identifying the corresponding product(s) and/or characteristics or traits thereof to the example product identifier 200 of FIG. 2 (block 410).

In the illustrated example, the example panelist profile generator 202 of FIG. 2 generates a profile for the panelist 106 (block 412). In the illustrated example, the panelist profile generator 202 uses information from, for example, the product database 218 and/or the demographic database 214 to generate the profile for the panelist 106. Generally, the profile of the panelist 106 is representative of aspects of purchasing behavior, consumption habits, and/or other trends of the panelist 106 and/or the household 108.

In the illustrated example, the example profile comparator 208 generates comparative data using the panelist profile and one or more composite profiles corresponding to a population having similar demographics as the household 108 (block 414). As described above, the example population profile generator 204 of FIG. 2 combines the information provided by the panelist 106 and the other panelists to form composite profile(s) indicative of, for example, purchasing behaviors and/or consumption activities of a plurality of populations. Thus, the comparative data generated by the example profile comparator 208 is indicative of a relationship between, for example, the shopping habits and/or consumption behavior of the household 108 and one or more segments of a population having one or more similar demographic characteristics as the household 108.

The example presentation generator 210 of FIG. 1 generates a presentation including, for example, purchase information related to the products 114 purchased by the panelist 106, one or more aspects of the panelist profile generated by the panelist profile generator 202, one or more comparisons between the panelist profile and one or more composite profiles associated with those of similar demographic(s) as the panelist 106, and one or more offers from one or more retailers (block 416). In the illustrated example, the panelist 106 can use the information conveyed via the presentation (e.g., the example presentation 300 of FIG. 3) to become better informed on the shopping trends, consumption habits, health and wellness, etc. of the household 108. To view the presentation, the panelist 106 can access the portal 212 of the example panelist feedback provider 122 via, for example, the personal computer 120. In the illustrated example, the portal 212 routes the panelist 106 to a website on which the presentation is available.

When the portal 212 is accessed by the panelist 106 (block 418), the presentation (e.g., the example presentation 300 of FIG. 3) is conveyed to a device accessing the portal 212 (e.g., the personal computer 120) (block 420). When new codes and/or other data are received at the panelist feedback provider 122 (block 422), control returns to block 404. Otherwise, control returns to block 418.

FIG. 5 is a block diagram of an example computer 500 capable of executing the instructions of FIG. 4 to implement the example panelist feedback provider 122 of FIGS. 1 and/or 2. The computer 500 can be, for example, a server, a personal computer, a mobile phone (e.g., a cell phone), a personal digital assistant (PDA), an Internet appliance, a set top box, or any other type of computing device.

The computer 500 of the instant example includes a processor 512. For example, the processor 512 can be implemented by one or more Intel® microprocessors from the Pentium® family, the Itanium® family or the XScale® family. Of course, other processors from other families are also appropriate.

The processor 512 is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 516 may be implemented by flash memory and/or any other desired type of memory device. Access to the main memory 514, 516 is typically controlled by a memory controller (not shown).

The computer 500 also includes an interface circuit 520. The interface circuit 520 may be implemented by any type of interface standard, such as an Ethernet interface, a universal serial bus (USB), and/or a PCI express interface.

One or more input devices 522 are connected to the interface circuit 520. The input device(s) 522 permit a user to enter data and commands into the processor 512. The input device(s) can be implemented by, for example, a keyboard, a mouse, a touchscreen, a track-pad, a trackball, isopoint and/or a voice recognition system.

One or more output devices 524 are also connected to the interface circuit 520. The output devices 524 can be implemented, for example, by display devices (e.g., a liquid crystal display, a cathode ray tube display (CRT), a printer and/or speakers). The interface circuit 520, thus, typically includes a graphics driver card.

The interface circuit 520 also includes a communication device (e.g., the request servicer) such as a modem or network interface card to facilitate exchange of data with external computers via a network 526 (e.g., an Ethernet connection, a digital subscriber line (DSL), a telephone line, coaxial cable, a cellular telephone system, etc.).

The computer 500 also includes one or more mass storage devices 528 for storing software and data. Examples of such mass storage devices 528 include floppy disk drives, hard drive disks, compact disk drives, and digital versatile disk (DVD) drives. The mass storage device 528 may implement the storage database 160.

The coded instructions of FIG. 4 may be stored in the mass storage device 528, in the volatile memory 514, in the non-volatile memory 516, and/or on a removable storage medium such as a CD or DVD.

From the foregoing, it will appreciate that the above disclosed methods, apparatus and articles of manufacture provide panelists with different types of information related to data related to purchases made by the panelists and/or members of households to which the panelists belong. The panelists can use the information conveyed via the disclosed methods, apparatus, and articles of manufacture described herein to become better informed on, for example, the shopping habits, potential savings, consumption trends, and/or health and wellness of the household 108. This can lead to better purchasing decisions from, for example, a financial standpoint and from a health standpoint. That is, the example methods, apparatus and articles of manufacture described herein enable panelists to evaluate, track, and improve the efficient utilization of a budget and the eating habits of the household 108, for example. Furthermore, the example methods, apparatus and articles of manufacture described herein inform panelists on how the behavior and/or habits of the household 108 compare with other groups of people, such as neighbors or demographically similar people. Panelist can utilize such information to set a goal for improving, for example, overall health and wellness of the household 108 by altering the foods purchased for the household 108. Additional and alternative benefits and uses of the example methods, apparatus and articles of manufacture described herein will be readily apparent from the drawings and the above description.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method of generating and presenting information to panelists, comprising:
receiving product data associated with a product purchased by a panelist;
generating a first profile for the panelist based on a characteristic related to the product;
generating comparative data between the first profile for the panelist and a composite profile related to a population; and
conveying the comparative data to the panelist.

2. A method as defined in claim 1, wherein the population has a demographic characteristic in common with the panelist.

3. A method as defined in claim 1, further comprising conveying the first profile to the panelist.

4. A method as defined in claim 1, the product data comprises a code corresponding to product purchased by the panelist.

5. A method as defined in claim 1, wherein the product data is obtained via a barcode scanner used by the panelist to scan the purchased product.

6. A method as defined in claim 1, wherein the characteristic is indicative of nutritional data associated with the product.

7. A method as defined in claim 6, wherein the comparative data includes a wellness ranking for the panelist relative to the population.

8. A tangible machine readable medium having instructions stored thereon that, when executed, cause a machine to at least:
receive product data associated with a product purchased by a panelist;
generate a first profile for the panelist based on a characteristic related to the product;
generate comparative data between the first profile for the panelist and a composite profile related to a population; and
convey the comparative data to the panelist.

9. A tangible machine readable medium as defined in claim 8, wherein the population has of a demographic characteristic in common with the panelist.

10. A tangible machine readable medium as defined in claim 8, wherein the instructions cause the machine to convey the first profile to the panelist.

11. A tangible machine readable medium as defined in claim 8, wherein the product data comprises a code corresponding to the product purchased by the panelist.

12. A tangible machine readable medium as defined in claim 8, wherein the product data is obtained by a barcode scanner used by the panelist to scan the purchased product.

13. A tangible machine readable medium as defined in claim 8, wherein the characteristics is indicative of nutritional data associated with the products.

14. A tangible machine readable medium as defined in claim 13, wherein the comparative data includes a wellness ranking for the panelist relative to the population.

15. An apparatus, comprising:
a product identifier to query a product database with product data received from a panelist corresponding to a product purchased by the panelist;
a panelist profile generator to generate a profile for the panelist based on a characteristic associated with the purchased product and received from the product database;
a population profile generator to generate a composite profile representative of products purchased by a segment of a population;
a comparator to compare the panelist profile to the composite profile to generate comparative data between the product purchased by the panelist and the products purchased by the segment of the population; and
a presentation generator to generate a presentation using the panelist profile and the comparative data generated by the comparator.

16. An apparatus as defined in claim 15, further comprising a communication device to communicate the presentation to the panelist.

17. An apparatus as defined in claim 15, further comprising a retailer database including a plurality of offers, at least one of the offers to be included in the presentation by the presentation generator.

18. An apparatus as defined in claim 15, further comprising a demographic identifier to determine a demographic associated with the panelist such that the population to be compared to the panelist is demographically similar to the panelist.

19. An apparatus as defined in claim 15, wherein the product data comprises a code received from the panelist via a barcode scanner.

20. An apparatus as defined in claim 15, wherein the comparative data includes a wellness ranking for the panelist relative to the population.
